(19) United States
(12) Patent Application Publication
(10) Pub. No.: US 2007/0155346 A1
(43) Pub. Date: Jul. 5, 2007

(54) Transcoding method in a mobile communications system

(75) Inventors: Vladimir Mijatovic, Espoo (FI); Claudio Cipolloni, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/350,903

(22) Filed: Feb. 10, 2006

(30) Foreign Application Priority Data
Dec. 30, 2005 (FI) 20055717

(51) Int. Cl. H04B 1/38

(52) U.S. Cl. 455/90.2

(57) ABSTRACT

The present invention involves a method that allows a user of a Push-to-talk over Cellular PoC system to select more flexibly the mode of transmitting. By means of the present invention, the user of a PoC terminal (UE1) is able to send text during an ongoing PoC session to a PoC server (PS) which transcodes the text into speech before transmitting it to the other participants (UE2) of the PoC session. Additionally, the method allows a speech-to-text transcoding act, for example, in order to add subtitles to a video clip that is shown during a video-PoC session. Further, the method allows speech-to-speech transcoding in order to replace the sender's own speech with another speech or voice during a PoC session. In addition to the text-to-speech, speech-to-text and/or speech-to-speech transcoding, the PoC server (PS) may be arranged to translate the received data into another language and to send the translated data to the recipients or back to the sender.

### FIELD OF THE INVENTION

The present solution relates to a method of code conversion for providing enhanced communications services to a user in a mobile communications system.

### BACKGROUND OF THE INVENTION

One special feature offered in mobile communications systems is group communication. Conventionally group communication has been available in trunked mobile communications systems, such as Professional Radio or Private Mobile Radio (PMR) systems, such as TETRA (Terrestrial Trunked Radio), which are special radio systems primarily intended for professional and governmental users, such as the police, military forces, oil plants.

Group communication with a push-to-talk feature is one of the available solutions. Generally, in voice communication provided with a “push-to-talk, release-to-listen” feature, a group call is based on the use of a pressel (push-to-talk button) as a switch. By pressing the pressel the user indicates his/her desire to speak, and the user equipment sends a service request to the network. The network either rejects the request or allocates the requested resources on the basis of predetermined criteria, such as the availability of resources, priority of the requesting user, etc. At the same time, a connection may also be established to other users in a specific subscriber group. When the voice connection has been established, the requesting user can talk and the other users can listen on the channel. When the user releases the pressel, the user equipment signals a release message to the network, and the resources are released. Thus, instead of being reserved for a “call”, the resources are reserved only for the actual speech transaction or speech item.

The group communication is now becoming available also in public mobile communications systems. New packet-based group voice and data services are being developed for cellular networks, especially in the evolution of the GSM/GPRS/UMTS network. According to some approaches, the group communication service, and also one-to-one communication, is provided as a packet-based user or application level service in which the underlying communications system only provides the basic connections (i.e. IP (Internet protocol) connections) between the group communications applications in the user terminals and the group communication service. The group communication service can be provided by a group communication server system while the group client applications reside in the user equipment or terminals. When this approach is employed for push-to-talk communication, the concept is also referred to as Push-to-talk over Cellular (PoC) network. Push-to-talk over Cellular is an overlay speech service in a mobile cellular network where a connection between two or more parties is established (typically) for a longer period, but the actual radio channels in the air interface are activated only when somebody is talking.

A disadvantage of the current PoC systems is that the users of a PoC service are expected to be able to “talk” and/or “listen”, i.e. to engage in voice communication, in order to be able to take part in the PoC communication.

### BRIEF DESCRIPTION OF THE INVENTION

It is thus an object of the present invention to provide a method, a system, a network node and a mobile station for implementing the method so as to alleviate the above disadvantage. The objects of the present invention are achieved by a method and an arrangement characterized by what is stated in the independent claims. The preferred embodiments are disclosed in the dependent claims.

According to a first aspect of the invention, during a communication session, such as a PoC session, a first user terminal is arranged to transmit, after having received a text inserted by a user, corresponding text-coded data to a network node. On the basis of the text-coded data received at the network node, the network node is arranged to generate an output comprising speech-coded data. The output includes the semantics of the text-coded data.

According to a second aspect of the invention, during a communication session, such as a PoC session, a first user terminal is arranged to transmit, after having received speech from a user, corresponding speech-coded data to a network node. On basis of the speech-coded data received at the network node, the network node is arranged to generate an output comprising text-coded data. The output includes the semantics of the speech-coded data.

According to a third aspect of the invention, during a communication session, such as a PoC session, a first user terminal is arranged to transmit, after having received speech from a user, corresponding first speech-coded data to a network node. On the basis of the first speech-coded data received at the network node, the network node is arranged to generate converted data. On the basis of the generated converted data the network node is arranged to then generate an output comprising second speech-coded data. The converted data and the output include the semantics of the first speech-coded data.

According to a fourth aspect of the invention, the user terminal is arranged, after receiving text-coded or speech-coded input data from the user, by means of a communication session, such as a PoC session, to transmit corresponding input data to the network node. The network node is arranged to perform at least one code conversion on the received input data to generate converted data. On the basis of the generated converted data, the network node is arranged to then generate an output comprising speech-coded data or text-coded output data, and to transmit the output from the network node to the user terminal. The converted data includes the semantics of the input data in a transcoded form. The output data includes the semantics of the input data in a translated form.

An advantageous feature of the first aspect of the present solution is that it allows a speaking-impaired person to participate in a group communication session, such as a PoC session. It also allows the PoC user to communicate in a place where speaking is not allowed. The second aspect of the present solution enables including subtitles into a video that is being played in a video-PoC session. It allows a hearing-impaired person to participate in a PoC session. An advantageous feature of the third aspect of the present solution is that the user may participate in the PoC session anonymously, without revealing his/her real identity to the other participants, as s/he is able to use an anonymous identity and/or artificial voice. The fourth aspect of the present solution allows the user to use a PoC terminal for obtaining a translation of a word or a sentence into another language. According to the fourth aspect, the user is able to send text and receive the translation in the form of speech, send speech and receive the translation in the form of text, and/or send speech and receive the translation in the form of speech. By means of the present solution, the user is able to have speech or text translated or embedded into other media, for example, text or translated text may be superimposed or embedded in a video stream, which has an effect similar to video stream subtitles.

### BRIEF DESCRIPTION OF THE DRAWINGS

In the following the invention will be described in greater detail by means of embodiments with reference to the accompanying drawings, in which

FIG. 1 illustrates a telecommunication system according to the present solution;

FIGS. 2 and 3 illustrate signalling according to the present solution;

FIG. 4 is a flow chart illustrating the function of a PoC server according to the present solution.

### DETAILED DESCRIPTION OF THE INVENTION

The embodiments of the present solution will be described below implemented in a 3G WCDMA (3^{rd} generation Wideband code division multiple access) mobile communication system, such as the UMTS (Universal mobile telecommunications system). However, the invention is not restricted to these embodiments, but it can be applied in any communication system capable of providing push-to-talk and/or so called “Rich Call” services. Examples of such mobile systems include IMT-2000, IS-41, CDMA2000, GSM (Global system for mobile communications) or other similar mobile communication systems, such as the PCS (Personal communication system) or the DCS 1800 (Digital cellular system for 1800 MHz). The invention may also be utilized in any IP-based communication system, such as in the Internet. Specifications of communications systems in general and of the IMT-2000 and the UMTS in particular are being developed rapidly. Such a development may require additional changes to be made to the present solution. Therefore, all the words and expressions should be interpreted as broadly as possible and they are only intended to illustrate and not to restrict the invention. What is essential for the present solution is the function itself and not the network element or the device in which the function is implemented.

The concept of the Push-to-talk over Cellular system PoC is, from an end-user point of view, similar to the short-wave radio and professional radio technologies. The user pushes a button, and after s/he has received a “ready to talk” signal, meaning that the user has reserved the floor for talking, s/he can talk while keeping the PTT button pressed. The other users, i.e. members of the group in case of a group call, or one recipient in case of a 1-to-1 call, are listening. The term “sender” may be used to refer to a user that talks at certain point of time (or, according to the present solution, transmits text or multimedia). The term “recipient” may be used to refer to a user that listens to an incoming talk burst (or, according to the present solution, receives text or multimedia). In this context, the term “talk burst” is used to refer to a shortish, uninterrupted stream of talk sent by a single user during a PoC session.

The present solution may also be applied to an arrangement implementing Rich Call. The Rich Call concept generally refers to a call combining different media and services, such as voice, video and mobile multimedia messaging, into a single call session. It applies efficient Internet protocol (IP) technology in a mobile network, such as so-called AII-IP technology. In this context the Rich Call feature may be implemented into a PoC system or it may be implemented into a mobile system that is not a PoC system.

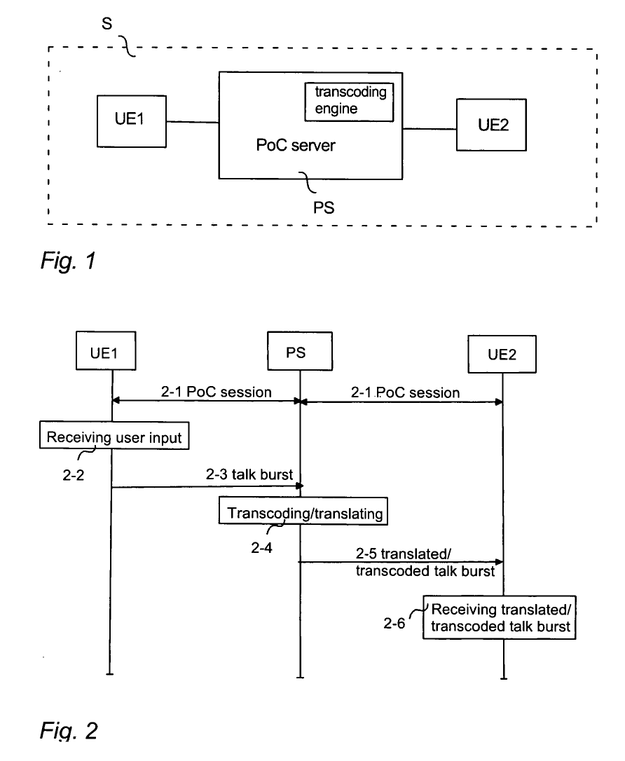

FIG. 1 illustrates a telecommunications system S to which the principles of the present solution may be applied. In FIG. 1, a Push-to-talk over Cellular talk group server PS, i.e. a PoC server, is provided e.g. on top of a packet switched mobile network (not shown) in order to provide a packet mode (e.g. IP) voice, data and/or multimedia communication services to at least one user equipment UE1, UE2. The user equipment UE1, UE2 may be a mobile terminal, such as a PoC terminal, utilizing the packet-mode communication services provided by the PoC server PS of the system S. The PoC system comprises several functional entities on top of the cellular network, which are not described in further detail here. The user functionality runs over the cellular network, which provides the data transfer services for the PoC system. The PoC system can also be seen as a core network using the cellular network as a radio access network. The underlying cellular network can be, for example, a general packet radio system (GPRS) or a third generation (3G) radio access network. It should also be appreciated that the present solution does not need to be restricted to mobile stations and mobile systems but the terminal can be any terminal having a voice communication or multimedia capability in a communications system. For example, the user terminal may be a terminal (such as a personal computer PC) having Internet access and a VolP capability for voice communication over the Internet. It should be noted that a participant of a PoC session does not necessarily have to be a user terminal, it may also be a PoC client or some other client, such as an application server or an automated system. The term “automated system” refers to a machine emulating a user of the PoC system and behaving as an “intelligent” participant in the PoC session, i.e. it refers to a computer-generated user having artificial intelligence. It may also be a simple pre-recorded message activated, for example, by means of a keyword. There may be a plurality of communication servers, i.e. PoC servers, in the PoC system, but for reasons of clarity only one PoC server is shown in FIG. 1. The PoC server comprises control-plane functions and user-plane functions providing packet mode server applications that communicate with the communication client application(s) in the user equipment UE1, UE2 over the IP connections provided by the communication system. The PoC server PS according to the present solution may include a transcoding engine, or the transcoding engine may be a separate entity connected to the PoC server PS.

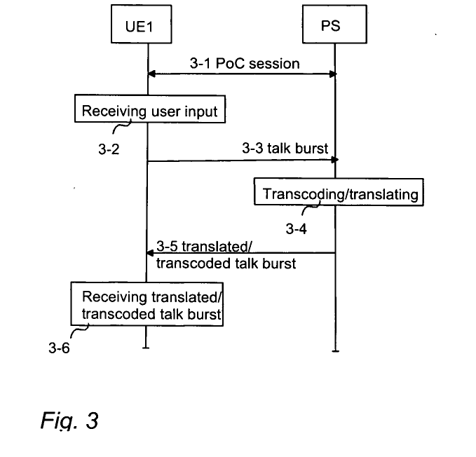

FIG. 2 illustrates, by way of example, the signaling according to an embodiment of the present solution. In FIG. 2, a PoC communication session, which may also be referred to as a “PoC call”, is established 2-1 between at least one user equipment UE1, UE2 and the PoC server PS. In step 2-2, an input received from a user of a first user equipment is registered, i.e. detected, in the first user equipment UE1. The received user input may comprise voice (speech), text and/or multimedia from the user. The user input may further comprise an indication whether (and how) the input should be transcoded (e.g. text-to-speech) and/or translated (e.g. Finnish-to-English) by the PoC server PS. The term “transcoding” refers to performing a code conversion of digital signals in one code to corresponding signals in a different code. Code conversion enables the carrying of signals in different types of networks or systems. The user equipment may be arranged to detect information on a language selected by the user or on a default language. Then, a corresponding talk burst (or text or multimedia) is transmitted 2-3 from the first user equipment UE1 to the PoC server PS. This means that the user has used the push-to-talk button in order to speak or send text or multimedia during the session. In connection with the talk burst, information may be transmitted on whether, and how, the talk burst is to be transcoded and/or translated by the PoC server PS. In step 2-4, the talk burst is received in the PoC server PS. After receiving the talk burst in step 2-4, the PoC server is arranged to check whether the talk burst comprises data that should be transcoded and/or translated. After that, it carries out 2-4 the appropriate speech-to-text, text-to-text (e.g. language translation) and/or text-to-speech transcoding as described below, in order to provide an output talk burst. Then, the output talk burst (comprising voice, text, or multimedia) is transmitted 2-5 to the at least one second user equipment UE2. In step 2-6, the output talk burst is received in at least one second user equipment UE2. Alternatively, in step 2-4, the PoC server may be arranged to store the output talk burst without sending it to UE2. This allows the sending of the transcoded message via some other means instead of or in addition to PoC. This also allows storing the (possibly transcoded) messages for some other purpose. Thus the output talk burst may, for example, be saved into a file and/or be transmitted (later) e.g. by e-mail or MMS (Multimedia Messaging Service). This option may be utilized for example in a situation where a sender for some reason wishes to send data at a postponed time schedule. This option may also be utilized for example in a situation where the system is arranged to send “welcome data” to users who later join to the group communication. Another option is that the output talk burst is provided to a PoC client or a server that stores the output talk burst.

FIG. 3 illustrates, by way of example, the signaling according to another embodiment of the present solution. In FIG. 3, a PoC communication session, which may also be referred to as a “PoC call”, is established 3-1 between a user equipment UE1 and a PoC server PS. In step 3-2, an input is received in the first user equipment UE1 from a user of the user equipment. The received user input may comprise voice, text and/or multimedia from the user. The user input may also comprise an indication whether (and how) the input is to be transcoded and/or translated by the PoC server PS. The user equipment may be arranged to detect information on a language selected by the user, e.g. by using a presence server, or on a default language. The presence server may be an entity located in the PoC server, or a different product. The presence server maintains user presence data (such as “available”, “busy”, “do not disturb”, location, time zone) and user preference data (such as language preferences). Then, a corresponding talk burst (or text or multimedia) is transmitted 3-3 from the user equipment UE1 to the PoC server PS. This means that the user has used the push-to-talk button in order to speak or send text or multimedia during the session. In connection with the talk burst, information may be transmitted whether, and how, the talk burst is to be transcoded and/or translated. In step 3-4, the talk burst is received in the PoC server PS. After receiving the talk burst in step 3-4, the PoC server is arranged to check whether the talk burst comprises data that should be transcoded and/or translated. After that it carries out the appropriate speech-to-text, text-to-text (e.g. language translation) and/or text-to-speech transcoding as described below, in order to provide an output talk burst. Then, the output talk burst (comprising voice, text or multimedia) is transmitted 3-5 back to the user equipment UE1. In step 3-6, the output talk burst is received in the user equipment UE1.

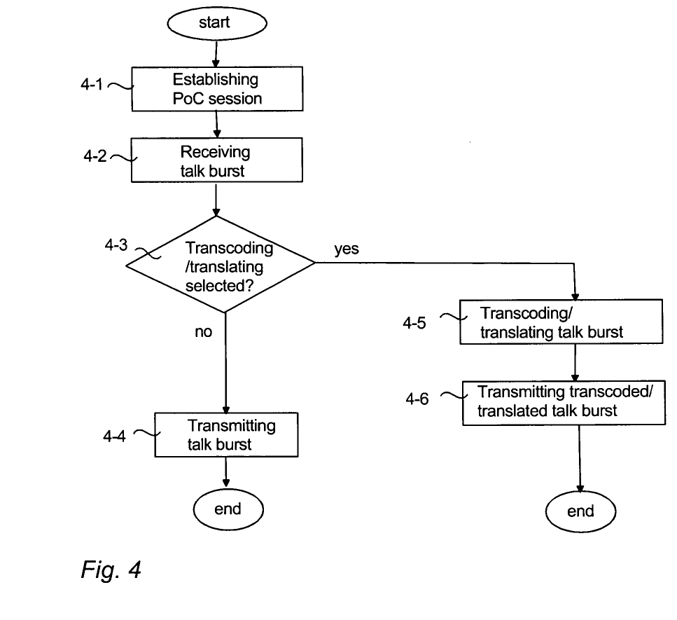

FIG. 4 is a flow chart illustrating the function of a PoC server PS according to the present solution. In step 4-1, a PoC communication session is established. In step 4-2, a talk burst (or text or multimedia) is received from a first user equipment UE1. The talk burst (or text or multimedia) may also comprise information on whether, and/or how, it is to be transcoded and/or translated in the PoC server. The talk burst may further comprise information on a language selected by the user or on a default language. Thus, after receiving the talk burst, the PoC server PS is arranged to check, in step 4-3, whether the talk burst comprises data that should be transcoded and/or translated, and/or how the information may be found in the presence server (or some other location where the user's preferences are defined). If no transcoding and/or translating is required, the PoC server forwards 4-4 the talk burst to the other participants of the PoC session. If transcoding and/or translating is required, the PoC server PS carries out 4-5 the appropriate speech-to-text, text-to-text (e.g. language translation) and/or text-to-speech transcoding as described below. -After that, the transcoded and/or translated talk burst is transmitted to the other participants (or as in the case of FIG. 3, back to the sender) of the PoC session. It should be noted that a participant of a PoC session may also be a PoC client, and thus, according to the present solution, the transcoded and/or translated talk burst may be provided to a PoC client or a server. Alternatively, in step 4-5, the PoC server may be arranged to store the transcoded and/or translated talk burst without sending it to UE2. In this case the output talk burst may, for example, be saved into a file and/or be transmitted (later).

In the following, the text-to-speech, text-to-text and speech-to-text transcoding/translating operations according to the present solution are described further.

Text-to-speech

The text-to-speech PoC (or Rich Call) application according to the present solution allows the user to send text to the application, and have it transcoded into speech. The user may turn the text-to-speech feature on or off by means of a PoC client. By doing so, the user may change his/her PoC status, so that the text-to-speech transcoding is enabled. A PoC server receives 2-4, 4-2 text from the user and transcodes 2-4, 4-5 the text into speech. It may be possible for the transcoding engine to decide the language of the talk burst, or the sender and/or the recipient may be able to set a default text-to-speech language by means of the PoC client.

The text-to-speech application may allow the user to send alternatively text and talk bursts. The sender may wish to send sometimes text and sometimes talk bursts during the same PoC session. In this case, the text-to-speech transcoding is performed in addition to the normal PoC service (i.e. real-time voice). If the sender sends a talk burst, it is transmitted to the recipient(s) via the PoC server PS. If the sender sends 2-3 an input comprising text-coded data, the text-coded data is transcoded 2-4, 4-5 into speech by the PoC server, and the speech-coded data is then transmitted 2-5 to the recipient as a corresponding talk burst.

The text-to-speech application may allow the user to utilize a feature that speaks out the text typed by the user. The user may send 3-3 text to the PoC application, and receive 3-6 back the corresponding “spoken” text. This may be useful for the user if s/he wishes to get an idea of how the text sounds when it is transcoded into speech by the text-to-speech transcoding engine in the PoC server PS. The sender is thus able to listen to the text transcoded into speech by means of a specific language-reader service, so that the sender gets to hear a proper pronunciation of a word or a sentence. This feature is also useful for speaking-impaired persons.

The PoC service transcodes the text into the speech according to preferences set by the user, or according to default preferences. The PoC server PS may comprise an additional component called transcoding function (also referred to as a transcoding engine). The component may be located inside or outside of the actual PoC server PS. The transcoding functionality of the transcoding function is used for the text-to-speech transcoding. The client may request such functionality from the PoC server by changing a respective PoC presence status. For example, a PoC presence status may be of the following form:

<PoC Text-To-Speech>

<Transcoding>[Off, On]</Transcoding>
<Default Language>

[English,Serbian,Italian,Finnish, . . .]

</Default Language>

</PoC Text-To-Speech>

The transcoding function may be turned on or off. If the transcoding is on, the server transcodes the text sent by the sender into speech and then sends it to the recipient(s). The default language may be the language that the sender is using. If the default language field is empty, the PoC server may be arranged to use its own default settings (e.g. Finnish language for operators in Finland) or to recognize the used language. The term “presence status” or “presence server” used herein do not necessarily have to refer to PoC presence, they may also be used to refer to generic presence or generic presence attributes for some other type of communication, such as full-duplex speech and/or instant messaging sessions.

When the PoC server is to transcode text into speech, in order to be transmitted to certain recipients (or to a certain recipient), the server will invoke the transcoding function. The transcoding function may be an existing text-to-speech transcoder, and it carries out the actual transcoding of text into speech. The server receives 2-4, 3-4, 4-2 the text from the sender and transcodes 2-4, 3-4, 4-5 it (according to the sender's PoC presence preferences). For example, if the preferences are: Transcoding=On, Default Language=English, the transcoding engine will use these preferences for transcoding the text into a talk burst. The talk burst is then transmitted 2-5, 3-5, 4-6 to the recipient(s) (or in case of FIG. 3, back to the sender).

The implementation in the PoC client allows the sender to send text in a PoC 1-to-1 or group conversation. The sender is able to send text which is then transcoded in the PoC server, and the transcoded text (i.e. talk burst) is sent from the PoC server to the recipient(s). This functionality may be utilized together with the speech-to-text functionality. In other words, the user may choose to use only text-to-speech, only speech-to-text, or both simultaneously. The PoC client may allow the user to choose his/her transcoding preferences from a menu. This enables the user to choose the default language, etc. The implementation may allow the transcoding preferences to be chosen by means of keywords or key symbols included in the typed text. For example, if the sender types in the beginning of the text “LANG:ENGLISH” or “*En*”, the transcoding function may be arranged to use this information for transcoding, and as a result of this, a voice reads the text in English.

The text-to-speech application according to the present solution enables the PoC service to be used by hearing/speaking-impaired users, or by users that are in an environment where ordinary usage of the PoC service is not possible. Some users (e.g. teenagers) may find it easier to send text in the group conversation than to speak with their own voice. This approach enables the anonymity of the user to be kept, as the user does not necessarily have to use his/her own voice in the conversation.

The transcoding (text-to-speech) should be carried out in a usable way. To be able to correctly decode most of the transmitted speech it should be of high quality. Therefore, an existing text-to-speech component available on the market may be used.

The aspects described above are not mandatory. In other words, text-to-speech transcoding may be used in a default mode (e.g. translation from English text to English voice), without the possibility that the subscriber chooses the language, etc.

There are several situations, where the recipient may be interested in utilising text-to-speech transcoding in PoC. For example, if the sender is speaking-impaired, the conventional Push-to-talk over Cellular service may be difficult or even impossible to use. In addition, the advanced PoC services, such as “video PoC” or “Rich Call”, are not usable for the speaking-impaired persons since the sender is not able, partially or fully, to send talk bursts because s/he is not able to speak properly, and is thus unable to take part in a PoC conversation. On the other hand, the sender may be in a place that requires silent usage of the service. This means that if the recipient is in an environment where talking and/or listening is not possible (e.g. in a theatre, school, or meeting) the usage of the PoC service is not possible with the conventional implementation, i.e. the user is not able to send speech to the PoC application (because of the restrictive environment).

Speech-to-text (Video Clip Subtitles)

The “video PoC”, “see what I See”, or “Rich Call” concepts allow a mobile user to share a video stream in connection with PoC or other media sessions (group or 1-to-1 sessions). As a sender sends video stream any participant in the group may use the push-to-talk button in order to speak (i.e. to send talk bursts). The term “sender” refers to a user that talks at certain point of time, or sends video stream from his/her terminal. A recipient refers to a user that is listening to incoming talk bursts and/or viewing video streams.

There may be situations when a user wishes to participate in a video PoC session, but is not willing (or able) to receive the audio. If the recipient is hearing-impaired, the ordinary push-to-talk audio service is difficult or even impossible to use. The recipient may wish to use the push-to-talk audio and video (and possibly also some other media) but the recipient is not able hear the audio talk bursts. On the other hand, if the recipient is in a noisy environment, or in an environment where listening is not possible (like in a theatre, school, or meeting), the usage of the advanced PoC services is not possible with the conventional implementation. Therefore, the present solution allows talk bursts to be encoded to subtitles. According to the present solution, the recipient is able to turn a video stream subtitles feature on or off in the PoC client. This is an advantageous feature for example when the recipient is hearing-impaired, or the recipient is not able to listen to talk bursts for some other reason.

As noted above, the recipient may be in a place that requires “silent” usage of the PoC service. A video stream subtitles option included in the PoC client allows the recipient to receive simultaneously video stream (i.e. a video clip) and a talk burst. This involves the PoC server PS being arranged to receive 2-4, 4-2 an incoming talk burst from the sender UE1, transcode 2-4, 4-5 it into text, embed the text (as subtitles) to the video stream, and transmit 2-5, 4-6 the video stream with the embedded text to the recipient UE2.

The transcoding engine may be arranged to decide the language of the text. Alternatively, the recipient (or the sender) may be able to set a default speech-to-text language by means of the PoC client. The addition of subtitles may also be implemented in such a way that the audio of the video clip is kept. If the recipient is in a “quiet speech-to-text” mode the audio is not sent to him/her. It is also possible that the incoming talk burst comes from a PoC group session different from the one where the video comes from; for example, the video may be shared in a group “Friends”, and the talk burst may come from a group “Family”. Also in this case the PoC server is arranged to embed the text into the video stream, but it may be shown in a different way. For example, the name of the group from which the talk burst comes may be put in front of the text, text from the same group may be merged in the video, text from another group may be shown by means of a vertically or horizontally scrolling banner, or different colours may be used.

The speech-to-text transcoding is carried out by means of a transcoding function component (i.e. a transcoding engine). The transcoding function component may be located inside or outside of the PoC server PS. Thus the PoC service uses the transcoding functionality of the transcoding function component for the speech-to-text transcoding. In addition, the PoC server has a component for editing (and/or mixing) the video streams. The component may be referred to as an editing component (not shown in FIG. 1), and it may be located inside or outside of the PoC server PS. The editing (or mixing) component is able to receive 2-4, 4-2 the video stream, and embed the text in the form of subtitles into the video stream in order to provide a modified video stream. After that the modified stream is transmitted 2-5, 4-6 as data packets from the PoC server PS to the recipient(s) UE2. It may also send separately audio and video stream with embedded synchronization information. Regardless of the technique used for embedding/mixing/superimposing of the video and text, the end result is the same from the recipient's point of view. Any particular method of adding the text to the video is not mandated by the present solution.

The PoC client may request the video clip subtitles functionality from the server by changing its PoC presence status. The PoC presence status of the client may look as follows:

<PoC Video Clip Speech-To-Text>

<Transcoding>[On, Off]</Transcoding>
<Language>

[English, Serbian, Italian, Finnish, . . . ]

</Language>
<Subtitles>

<Background>[On, Off]</Background>
<Background colour>

[Black, White, . . . ]

</Background colour>
<Font>

[Arial, Comic Sans MS, . . . ]

</Font>
<Font size>

[Large, Medium, Small]

</Font size>
<Font colour>

[Black, White, . . . ]

</Font colour>

</Subtitles>

</PoC Video Clip Speech-To-Text>

The client may change his/her “PoC video clip speech-to-text presence” at any time. When the transcoding PoC presence attribute is set to “on”, the server is arranged to receive incoming audio (i.e. video stream with embedded audio, or separate audio talk bursts), carry out the speech-to-text transcoding (a default language setting may be used, or the PoC server may be arranged to decide the language), embed text into the video as subtitles, and transmit 2-5, 4-6 the modified video stream to the appropriate recipient(s). The term “presence” used herein does not necessarily have to refer to PoC presence, it may also be used to refer to generic presence or generic presence attributes for some other type of communication, such as full-duplex video, audio and/or text messaging.

Thus the speech-to-text feature according to the present solution allows the video stream to be displayed on the screen of the user terminal together with the subtitles embedded/superimposed in the video stream. The user is able to turn the PoC video clip speech-to-text PoC presence function on or off. This may be carried out by means of a menu. In a submenu the user (i.e. the sender and/or the recipient) may be able to select a default transcoding language. If the default language is selected, the server is arranged to use the default language specified by the user. Otherwise, the server may be arranged to use default settings set by the service provider, or to recognize the language that is used.

This functionality may also be achieved, if the mixing server is arranged to send text and video streams separately, with or without the synchronization information. The mixing/superimposing/embedding of the text and video may be carried out on the client side according to the local user preferences. The user may locally choose to e.g. change the text position, size or colour in the video.

Insertion settings of the text over the video may be selected by the user. For example, the user may choose the appearance of the subtitles. The editing component in the PoC server may use the options selected by the user, or the server may be arranged to use default settings, or to adjust settings to the characteristics of the video (for instance, if the background is light, a dark background for subtitles may be used, and vice versa). It should be noted that the insertion of the text over the video might also be done on the client side. In this case the PoC server is arranged to send appropriate media streams separately (e.g. video stream and text stream in a selected language), and the client is arranged to take care of the synchronization and the displaying.

The speech-to-text transcoding should be done in a usable way. In order to be able to correctly decode speech it should be of a high quality. Therefore, an existing speech-to-text transcoding component may be used.

Virtual Identity

According to an embodiment of the present solution, a virtual identity feature may be included in the PoC system. There may be situations where a PoC user would like to use a virtual identity. If a sender wishes to take part in a chat group anonymously with a virtual identity, the PoC application allows sending speech using artificial voice and pictures or video clip stored and merged to a talk burst. Here, the sender refers to a user that talks or sends text or multimedia at a certain time point during a PoC session. The recipient is a user that receives a talk burst, text or multimedia. Again, it should be noted that the embodiment herein does not necessarily have to refer to a PoC communication system, but it may refer to any type of communication system for enabling video, audio, IP multimedia and/or some other media communication.

The user may wish to take part in a PoC session with a voice different from his/her own and/or to provide pictures or video clips together with the talk burst in order to create a virtual identity for him/herself. The sender may turn a virtual identity feature on or off in the PoC client. The virtual identity profile includes a set of “profile moods” selected by the user. These settings are also available to the PoC server. The PoC server PS is arranged to perform a series of multimedia modifications and/or additions on the sent text/audio/video before delivering to the recipient(s). These modifications and/or additions correspond to the profile moods set selected by the user.

In connection with the PoC server, an additional component called a transcoding function is provided. This component may be located inside or outside of the PoC server. The PoC service uses the transcoding functionality of the transcoding function component for performing an appropriate speech-to-text or text-to-speech transcoding operation(s) according to the present solution. Further, in connection with the PoC server, an additional component called a media function is provided. Also this component may be located inside or outside of the PoC server. The PoC service uses the functionality of the media function component for producing an artificial voice for a talk burst in cooperation with the transcoding function according to the sender profile moods, and for combining still pictures, video clips, animated 3D pictures etc. with talk bursts. The video stream and the talk burst are sent together to the recipient(s) in one or more simultaneous sessions.

For example, the virtual identity feature may be implemented, by means of presence XML settings, in the following way:

<PoC Virtual Identity>

<Voice>

<Status>[on, off]</Status>
<Language>

[English, Serbian, Italian, Finnish, . . . ]

</Language>
<Tune>

[Default Man, Default Woman, Angry
Man, Nice Woman, Electric, . . . ]

</Tune>

</Voice>
<Video>

<Status>[on, off]</Status>
<Type>

[Still 2D Picture, Animated 3D Face,
Recorded Clip, . . . ]

</Type>
<Source>

[http://photos.com/name/face1.jpg,
http://www.mail.com/demo.htm,
0709AB728725415C2A, . . . ]

</Source>

<Video>

</PoC Virtual Identity>

The profile attribute “Language” (<PoC Virtual Identity><Voice><Language>) refers to a default language that the sender is using. If this field is empty, the server may be arranged to use its own default setting (e.g. Finnish language for operators in Finland) or to try to recognise the used language. The profile attribute “Voice Tune” (<PoC Virtual Identity><Voice><Tune>) refers to a situation where the sender sends speech, text or multimedia to a group, and the recipient(s) receive a talk burst with a certain voice tune selected by the sender in his/her profile moods. As the sender sends 2-3 speech, the PoC server PS is arranged to transcode 2-4 it into text, and an artificial voice tune is created. The voice tune may be selected from a list of predefined voice samples as described above, or in a more detailed way for a component of human speech according to the following example:

<Default Language>

[English, Serbian, Italian, Finnish, . . . ]

</Default Language>
<Voice>[Male, Female, male child, female child, . . . ]</Voice>
<Mood>

[Normal, Happy, Ecstatic, Annoyed, Screaming, Crying, . . . ]

</Mood>
<Volume>[Normal, Whisper, Shout, . . . ]</Volume]
<Accent>

[English with Finnish Accent, English with Italian Accent, . . . ]

</Accent>
<Modulation>[Echo, High-Pitch, Radio-like, . . . ]</Modulation>

The attribute Still 2D Picture (<PoC Virtual Identity><Video><Type>Still Picture) refers to a feature where the recipient(s), receiving a talk burst, may simultaneously view a two-dimensional picture defined in the sender profile moods. The attribute Animated 3D Face (<PoC Virtual Identity><Video><Type>Animated 3D Face) refers to a feature where the recipient(s), receiving a talk burst, may view a three-dimensional animated face defined in the sender profile moods. A 3D animated face is a 2D picture of a face that is submitted to a process that makes it look like a 3D face that moves, and that may open and/or close the eyes and mouth when the sender talks. The attribute Recorded Video Clip (<PoC Virtual Identity><Video><Type>Recorded Clip) refers to a feature where the recipient(s) receiving a talk burst may view a video clip decided by the sender in his/her profile moods. If the video clip is longer than the speech, the video clip may be truncated, or the talk burst may continue silently. If the video clip is shorter than the speech, it may be repeated in a loop, or the last image may be kept on the screen of the recipient's terminal.

The user may join a Rich Call PoC group “friends”, and set his/her virtual identity in the following way:

<PoC Virtual Identity>

<Voice>

<Status>on</Status>
<Language>English</Language>
<Tune>Robot<Tune>

</Voice>
<Video>

<Status>on</Status>
<Type>Animated 3D Face</Type>
<Source>

http://www.mail.com/demo.htm

</Source>

</Video>

</PoC Virtual Identity>

The sender says to the group “I will terminate you all . . . ” by using a normal PoC talk. The server transcodes the speech to the artificially created speech of the Robot, and adds the video stream of the automated 3D face of the Robot. The recipients in the group see the “Animated 3D Face” of the Robot and hear the Robot's voice. The eyes and mouth of the Robot open and close as if it were talking. Thus the user is able to use a virtual identity in the group communication.

The user may join a “voice only” PoC group “Robot fans”. The user may set his/her virtual identity in the following way:

<PoC Virtual Identity>

<Voice>

<Status>on</Status>
<Language>English</Language>
<Tune>Robot</Tune>

</Voice>
<Video>

<Status>off</Status>

</Video>

</PoC Virtual Identity>

If the user says to the group “I will terminate you all . . . ”, the recipients will hear the Robot's voice. This enables the anonymity of the user. Thus the PoC service may be used with a virtual identity enhancing PoC chat groups. The PoC users may try different combinations of voice and video streams that are combined together.

The transcoding should be carried out in a usable way (speech-to-text). In order to be able to correctly decode most of the speech it should be of a high quality. If the speech is not decoded accurately enough, the end-user satisfaction may drop. Therefore, a state-of-the-art speech-to-text/text-to-speech component should be used.

Language Translation

A user may wish to participate in a 1-to-1 or group communication in a situation where the other participant(s) use a language that is unknown to the user. In a situation where the other participants of a PoC session use a language that the user is not able to speak or write, the conventional push-to-talk service is useless as the user is not able to take part in the conversation of the group. On the other hand the user may be in a situation where s/he would like to get a translation of a phrase. If the user needs a fast translation in a practical situation, like ordering chocolate in a foreign country, an instant translation service might be helpful. There are also a lot of other situations where a correct translation (possibly together with a correct pronunciation) would be useful. Thus the PoC application could be provided with an “automatic translation service”. In this context, the term sender refers to the user that talks or sends text at a certain point of time. The term recipient refers to the user that is listening to incoming talk bursts or receiving text.

In a situation where the sender does not know the language that is used in a group the sender may turn a language translation feature on or off in the PoC client, and the setting will be available in the server. This implies that the sender may speak to the group (send talk bursts or text) using a source language, and a PoC server is arranged to perform a language translation before delivering the translated talk burst to the other recipient(s). If the sender would like to get a fast translation in order to communicate directly with someone the user may send speech or text to an automatic translation service provider that performs the translation and delivers the translated speech and/or text back to the user. For instance, a user could send speech to a service provider providing Italian-to-English translations, and as a result receive real-time text and/or speech translation into English.

For example, the user may, while in a bar, send the following speech to the Italian-to-English service provider: “Vorrei una cioccolata calda, per piacere”. The speech gets translated into English language by the Italian-to-English service provider, and the PoC server delivers the talk burst with the translation back to the user: “I would like to have a hot chocolate, please”. The talk burst is then played by means of a loudspeaker of the user terminal, and the waiter may listen to and understand what the user wants.

The PoC server may have an additional component called a transcoding function. The component may be located inside or outside of the PoC server. The PoC service may utilize the transcoding functionality of the transcoding function component for transcoding speech-to-text or text-to-speech.

The speech translation is not necessarily carried out directly; therefore the speech-to-speech translation process may include: a speech-to-text transcoding step, a text-to-text translation step, and a text-to-speech transcoding step. The speech-to-text transcoding engine and the text-to-text translator may be arranged to automatically detect the source language, or the sender may be able to select a default speech and/or text language by means of the PoC client.

The language translation feature may be implemented as PoC presence XML settings in the following way:

<PoC Automatic Language Translation>

<Audio Translation>

<Status>[on, off]</Status>
<Source Language>

[English, Serbian, Italian, Finnish]

</Source Language>
<Destination Language>

[English, Serbian, Italian, Finnish]

</Destination Language>

</Audio Translation>
<Text Translation>

<Status>[on, off]</Status>
<Source Language>

[English, Serbian, Italian, Finnish]

</Source Language>
<Destination Language>

[English, Serbian, Italian, Finnish]

</Destination Language>

</Text Translation>

</PoC Automatic Language Translation>

The implementation in the client enables the client to request the functionality from the server by changing the PoC presence (or some generic presence) status in order to perform a translation. Thus a text-to-text translation may be performed, and the implementation may allow the preferences for the translation to be chosen by means of a keyword or a key symbol included in the typed text. For example, if the sender types in the beginning of the text “LANG:ITA-ENG”, the translation function is arranged to use this information for translating.

With this improvement the difficulty of the users having no language in common may be overcome, which increases the flexibility of the PoC service when used for international communication. The usage of a variety of features may be enhanced, such as transcoding speech into text, translating text, transcoding text into speech, and streaming text instead of voice. The language translation feature allows the recipients in a group to receive translated text or speech. Further, it allows the original sender of text or speech to get a translation of the text or speech.

The transcoding and the translating operations should be carried out in a usable way. Existing speech-to-text, text-to-speech and/or text-to-text (translation) components may be used.

The present invention enables the performance of the following transcoding or translation acts in a PoC or Rich Call system: text->speech, speech->text, speech->text->speech, text->text->speech, speech->text->text, speech->text->text->speech. However, it is obvious to a person skilled in the art that data handled only by the server and not visible to the user does not necessarily have to be in a text (or speech) format but it may be in some appropriate metafile format, such as file, email or any generic metadata format, as long as the semantics of the original input are kept in the final output received by the user.

The present invention enables the user to select the transmitting mode and/or the transcoding mode (i.e. speech or text).

The signalling messages and steps shown in FIGS. 2, 3 and 4 are simplified and aim only at describing the idea of the invention. Other signalling messages may be sent and/or other functions carried out between the messages and/or the steps. The signalling messages serve only as examples and they may contain only some of the information mentioned above. The messages may also include other information, and the titles of the messages may deviate from those given above.

In addition to prior art devices, the system, network nodes or user terminals implementing the operation according to the invention comprise means for receiving, generating or transmitting text-coded or speech-coded data as described above. The existing network nodes and user terminals comprise processors and memory, which may be used in the functions according to the invention. All the changes needed to implement the invention may be carried out by means of software routines that can be added or updated and/or routines contained in application specific integrated circuits (ASIC) and/or programmable circuits, such as an electrically programmable logic device EPLD or a field programmable gate array FPGA.

It will be obvious to a person skilled in the art that, as the technology advances, the inventive concept can be implemented in various ways. The invention and its embodiments are not limited to the examples described above but may vary within the scope of the claims.Claims

1. A method of code conversion in a mobile communications system comprising:
a first user equipment; and
a server network node,
the method comprising:
establishing by the server network node a communication session between the first user equipment and the server network node, and during the communication session receiving in the first user equipment an input burst from a first user of the first user equipment, wherein the input burst comprises text-coded data;
transmitting the input burst from the first user equipment to the server network node; and
receiving the input burst in the server network node,
the method further comprising generating, in the server network node, an output burst on the basis of the input burst, wherein the output burst comprises speech-coded data corresponding to said text-coded data.

2. A method as claimed in claim 1, wherein the method comprises transmitting the output burst from the server network node to at least one second user equipment participating in said communication session, and receiving the output burst in the at least one second user equipment.

3. A method as claimed in claim 1, wherein the method comprises storing said output burst in the server network node.

4. A method as claimed in claim 1, wherein the method comprises defining an artificial user identity for the first user of the first user equipment.

5. A method as claimed in claim 1, wherein the method comprises:
transcoding textual data received from the first user of the first user equipment into corresponding speech data; and
providing the speech data to a second user of the at least one second user equipment.

6. A method as claimed in claim 1, wherein the method comprises:
translating the text-coded data into another language in order to provide a translated text-coded data; and
generating the speech-coded data by utilizing the translated text-coded data.

7. A method as claimed in claim 1, wherein the method comprises:
detecting, in the server network node, a language of the input burst; and
translating the input burst into another language in order to provide the output burst.

8. A method as claimed in claim 1, wherein the method comprises performing a text-to-speech transcoding act in a Push-to-talk over Cellular PoC system.

9. A method as claimed in claim 8, wherein the text-to-speech transcoding act is performed by a transcoding engine associated with the server network node.

10. A method of code conversion in a mobile communications system comprising:
a first user equipment;
at least one second user equipment; and
a server network node,
the method comprising a step of establishing, by the server network node, a communication session between the first user equipment and the at least one second user equipment, and during the communication session, receiving in the first user equipment an input burst from a first user of the first user equipment, wherein the input burst comprises speech-coded data;
transmitting the input burst from the first user equipment to the network node; and
receiving the input burst in the server network node,
the method further comprising:
generating in the server network node an output burst on the basis of the input burst, wherein the generated output burst comprises text-coded data corresponding to the speech-coded data; and
transmitting said output burst from the server network node to the at least one second user equipment.

11. A method as claimed in claim 10, wherein the method comprises:
transmitting video-coded data from the server network node to the at least one second user equipment; and
embedding said text-coded data into the video-coded data as subtitles.

12. A method as claimed in claim 10, wherein the method comprises receiving the output burst in the at least one second user equipment.

13. A method as claimed in claim 10, wherein the method comprises defining an artificial user identity for the first user of the first user equipment.

14. A method as claimed in claim 10, wherein the method comprises:
transcoding spoken data received from the first user of the first user equipment into corresponding textual data; and
providing the textual data to a second user of the at least one second user equipment.

15. A method as claimed in claim 10, wherein before transmitting the text-coded data, the text-coded data is translated into another language.

16. A method as claimed in claim 10, wherein the method comprises:
detecting in the server network node a language of the input burst; and
translating the input burst into another language in order to provide the output burst.

17. A method as claimed in claim 10, wherein the method comprises performing a speech-to-text transcoding act in a Push-to-talk over Cellular PoC system.

18. A method as claimed in claim 10, wherein the speech-to-text transcoding act is performed by a transcoding engine associated with the server network node.

19. A method of code conversion in a mobile communications system comprising:
a first user equipment;
at least one second user equipment; and
a server network node,
the method comprising a step of establishing, by the server network node, a communication session between the first user equipment and the at least one second user equipment, and during the communication session, receiving in the first user equipment an input burst from a first user of the first user equipment, wherein the input burst comprises first speech-coded data, and transmitting the input burst from the first user equipment to the server network node, and receiving the input burst in the server network node,
the method further comprising:
generating in the server network node a first output burst on the basis of the input burst, wherein the first output burst comprises text-coded data corresponding to said first speech-coded data;
generating, in the server network node, a second output burst on the basis of the first output burst, wherein the second output burst comprises second speech-coded data corresponding to the text-coded data; and
transmitting said second output burst from the server network node to the at least one second user equipment.

20. A method as claimed in claim 19, wherein the method comprises receiving the second output burst in the at least one second user equipment.

21. A method as claimed in claim 19, wherein the method comprises defining an artificial user identity for the user of the first user equipment.

22. A method as claimed in claim 19, wherein the method comprises replacing the first output burst with a second output burst, wherein a speech tone of the first user of the first user equipment is replaced with a voice tone that is different from the speech tone of said first user.

23. A method as claimed in claim 19, wherein the method comprises:
transcoding first spoken data received from the first user of the first user equipment into corresponding textual data;
transcoding the textual data into corresponding second spoken data; and
providing the second spoken data to a second user of the at least one second user equipment.

24. A method as claimed in claim 19, wherein before transcoding into said second speech-coded data, the text-coded data is translated into another language.

25. A method as claimed in claim 19, wherein the method comprises performing a speech-to-speech transcoding act in a Push-to-talk over Cellular PoC system.

26. A method of code conversion in a mobile communications system comprising:
a user equipment; and
a server network node,
the method comprising a step of establishing a communication session between the user equipment and the server network node, and during the communication session receiving, in the user equipment, an input burst from a first user of the user equipment, wherein the input burst comprises first text-coded or speech-coded data;
transmitting the input burst from the user equipment to the server network node; and
receiving the input burst in the server network node,
the method further comprising:
generating in the server network node an output burst on the basis of the input burst, wherein the output burst comprises translated speech-coded or text-coded data corresponding to a translation of the first text-coded or speech-coded data into another language; and
transmitting said second output burst from the server network node to the user equipment.

27. A method as claimed in claim 26, wherein the method comprises receiving the second output burst in the user equipment.

28. A method as claimed in claim 26, wherein the method comprises performing a text-to-speech transcoding act in a Push-to-talk over Cellular PoC system.

29. A method as claimed in claim 26, wherein the method comprises performing a speech-to-text transcoding act in a Push-to-talk over Cellular PoC system.

30. A method as claimed in claim 1, wherein the communication session is a Push-to-talk over Cellular PoC session.

31. A method as claimed in claim 1, wherein the communication session is a Rich Call session.

32. A mobile communications system comprising:
a first user equipment; and
a server network node,
the system being capable of establishing by the server network node a communication session between the first user equipment and the server network node,
wherein, as a response to receiving an input burst comprising text-coded data, the first user equipment is configured to transmit the input burst to the server network node,
wherein, as a response to receiving the input burst, the server network node is configured to generate an output burst on the basis of the input burst, wherein the output burst comprises speech-coded data corresponding to said text-coded data.

33. A mobile communications system as claimed in claim 32, wherein the output burst is stored into the server network node.

34. A mobile communications system as claimed in claim 32, wherein the system is arranged to transmit the output burst to at least one second user equipment located in the system.

35. A mobile communications system comprising:
a first user equipment;
at least one second user equipment; and
a server network node,
the system being capable of establishing, by the server network node, a communication session between the first user equipment and the at least one second user equipment,
wherein, as a response to receiving an input burst comprising speech-coded data, the first user equipment is configured to transmit the input burst to the server network node,
wherein, as a response to receiving the input burst, the server network node is configured to generate an output burst on the basis of the input burst, wherein the output burst comprises text-coded data corresponding to said speech-coded data, and transmit the output burst to the at least one second user equipment.

36. A mobile communications system comprising:
a first user equipment;
at least one second user equipment; and
a server network node,
the system being capable of establishing, by the server network node, a communication session between the first user equipment and the at least one second user equipment,
wherein, as a response to receiving an input burst comprising speech-coded data, the first user equipment is configured to transmit the input burst to the server network node,
wherein, as a response to receiving the input burst, the server network node is configured to generate a first output burst on the basis of the input burst, wherein the first output burst comprises text-coded data corresponding to said first speech-coded data,
wherein the system is configured to generate a second output burst on the basis of the first output burst, wherein the second output burst comprises second speech-coded data corresponding to the text-coded data, and
wherein the system is configured to transmit said second output burst to the at least one second user equipment.

37. A mobile communications system comprising:
a user equipment; and
a server network node,
the system being capable of establishing a communication session between the user equipment and the server network node,
wherein, as a response to receiving an input burst comprising first text-coded or speech-coded data, the user equipment is configured to transmit the input burst to the server network node,
wherein, as a response to receiving the input burst, the server network node is configured to generate a first output burst on the basis of the input burst, wherein the first output burst comprises translated speech-coded or text-coded data corresponding to a translation of the first text-coded or speech-coded data into another language, and
wherein the system is configured to transmit said second output burst to the user equipment.

38. A server network node in a mobile communications system comprising a first user equipment, wherein the server network node is configured to establish a communication session with the first user equipment, and receive an input burst from the first user equipment, the input burst comprising text-coded data,
wherein the server network node is further configured to
generate an output burst on the basis of the input burst, wherein the output burst comprises speech-coded data corresponding to said text-coded data.

39. A server network node as claimed in claim 38, wherein the server network node is arranged to store the output burst.

40. A server network node as claimed in claim 38, wherein the server network node is arranged to transmit the output burst to at least one second user equipment in the mobile communications system.

41. A server network node as claimed in claim 38, wherein the server network node comprises a transcoding engine arranged to perform a text-to-speech transcoding act.

42. A server network node in a mobile communications system further comprising:
a first user equipment; and
at least one second user equipment,
wherein the server network node is configured to establish a communication session between the first user equipment and the at least one second user equipment, and receive an input burst from the first user equipment, the input burst comprising speech-coded data,
wherein the server network node is further configured to generate an output burst on the basis of the input burst, wherein the output burst comprises text-coded data corresponding to said speech-coded data, and wherein the server network node is configured to transmit the output burst to the at least one second user equipment.

43. A server network node as claimed in claim 42, wherein the server network node comprises a transcoding engine arranged to perform a speech-to-text transcoding act.

44. A server network node in a mobile communications system further comprising:
a first user equipment; and
at least one second user equipment,
wherein the server network node is configured to establish a communication session between the first user equipment and the at least one second user equipment, and receive an input burst from the first user equipment, the input burst comprising speech-coded data,
wherein the server network node is further configured to generate a first output burst on the basis of the input burst, wherein the first output burst comprises text-coded data corresponding to said first speech-coded data, to generate a second output burst on the basis of the first output burst, wherein the second output burst comprises second speech-coded data corresponding to the text-coded data, and to transmit said second output burst to the at least one second user equipment.

45. A server network node as claimed in claim 44, wherein the server network node comprises a transcoding engine arranged to perform a speech-to-speech transcoding act.

46. A server network node in a mobile communications system further comprising a user equipment, wherein the server network node is configured to:
establish a communication session between the user equipment and the server network node; and
receive an input burst from the user equipment, the input burst comprising first text-coded or speech-coded data,
wherein the server network node is further configured to generate a first output burst on the basis of the input burst, wherein the first output burst comprises translated speech-coded or text-coded data corresponding to a translation of the first text-coded or speech-coded data into another language, and transmit said second output burst to the user equipment.

47. A user equipment capable of communicating in a mobile communications system further comprising a server network node, wherein the user equipment is capable of communicating with the server network node, wherein the user equipment is a PoC terminal and comprises means for transmitting and/or receiving text during a PoC session.

48. The user equipment according to claim 47, wherein the user equipment comprises means for selecting a mode of transmitting or receiving in a PoC session.

49. The user equipment according to claim 47, wherein the user equipment comprises means for selecting the language of transmitting or receiving in a PoC session.
